(19) United States
(12) Patent Application Publication
(10) Pub. No.: US 2026/0216834 A1
(43) Pub. Date: Jul. 30, 2026

(54) System for Processing Workpieces for Producing Motor Vehicles

(71) Applicant: Bayerische Motoren Werke Aktiengesellschaft, Muenchen (DE)

(72) Inventors: Dominik EXNER, Otterfing (DE); Alexander GRIMM, Karlsfeld (DE); Matthias STANGL, Friedberg (DE)

(21) Appl. No.: 19/146,972

(22) PCT Filed: Mar. 11, 2024
(86) PCT No.: PCT/EP2024/056310

§ 371 Date: Jul. 10, 2025

(30) Foreign Application Priority Data
Mar. 31, 2023 (DE) 10 2023 108 300.7

(51) Int. Cl. B23P 21/00; B62D 65/18

(52) U.S. Cl. CPC B23P 21/004; B62D 65/18; B23P 2700/50

(57) ABSTRACT

A system for processing workpieces for producing motor vehicles, includes multiple work areas. The multiple work areas are arranged in a work plane, in each of which at least one work device is arranged, which is configured to process at least one workpiece. At least one transport device, which is movably arranged in a transport plane that is different from the work plane and that is configured to transport at least one object and/or one workpiece out of at least one work area or into at least one work area and/or to carry out at least one maintenance process on the at least one work device.

### BACKGROUND AND SUMMARY

The disclosure relates to a system for processing workpieces for producing motor vehicles, comprising multiple work areas arranged in a work plane, in each of which at least one work device is arranged, which is designed for processing at least one workpiece.

Systems for processing workpieces for producing motor vehicles are known in principle from the prior art. For example, such systems can comprise conveyor belts along which various work areas are arranged, in which individual processing steps can be carried out in succession. This design of the system is useful in particular for producing workpieces or motor vehicles in which a low variance exists, i.e. predominantly identical or similar motor vehicles are produced. However, if the variance increases, the individual workpieces, which form partially assembled motor vehicles or are used for producing different motor vehicles, for example, pass through the same work areas along the conveyor belt though this is not necessary for producing the individual motor vehicles or the individual motor vehicles have different equipment variants or body variants which require processing in different work areas.

For such a comparatively high variance in production, it is furthermore known from the prior art that the workpieces are processed in different work areas which all lie in the same work plane, but are not arranged along a common conveyor belt, but rather, depending on the respective motor vehicle to be produced, deliberate conveyance of the workpiece into the work areas intended for it can be achieved. The work areas form so-called “cells” in this example, in which, for example, a robot can carry out various processing steps. A large amount of logistical area is required in the work plane for each work device or each work area to execute or provide such cell-type work areas due to the parts supply, product removal, maintenance, and the like required for the operation of the work areas or work devices. This accordingly significantly increases the overall area requirement for the system.

It is an object of the present disclosure to specify a system for processing workpieces for producing motor vehicles improved in relation thereto, which in particular enables flexible processing of different workpieces with the smallest possible area requirement.

The object is achieved by a system as claimed in this disclosure. The claims also relate to possible embodiments.

As described, the disclosure relates to a system for processing workpieces for producing motor vehicles, comprising multiple work areas which are arranged in a work plane, in particular a common work plane. For example, a base area or a floor in a hall or a section of the system or a factory for producing motor vehicles can be understood as the work plane. At least one work device designed for processing at least one workpiece is arranged in each work area. The term “processing” can in principle relate to any activity which can be carried out by such a work device, for example, a multiaxis robot. Solely by way of example, the term processing can relate to machining, measuring, or assembling, especially joining two workpieces, forming, drilling, welding, adhesive bonding, painting, measuring, and any further processing steps.

The disclosure is based on the finding that at least one transport device is provided which is arranged, in particular movably, in a transport plane different from the work plane and is designed to transport at least one object and/or one workpiece out of at least one work area or into at least one work area and/or to carry out at least one maintenance process on the at least one work device. The disclosure therefore proposes arranging fundamentally different work areas in a work plane, in which single processing steps for producing the motor vehicle or processing the workpiece can be carried out individually. Due to the arrangement of the work areas in the same work plane, it is fundamentally possible to selectively supply the workpiece to the work area which processes the workpiece in the course of a process required for producing the motor vehicle. The present system can therefore already be distinguished in relation to systems which are based on the principle of a conveyor belt which runs through all work areas.

The at least one transport device provided is located in a transport plane which is different from the work plane. The disclosure thus especially proposes that the work plane and the transport plane are different, i.e. that the transport and the processing are carried out on different planes. The necessity of providing logistics areas in the area of the work plane, which typically contribute to a significant enlargement of the area requirement, is thus eliminated. Instead, such logistics areas are relocated into the transport plane, thus effecting a separation of the planes in which the processing takes place and in which the transport or the logistics take place.

As described, the transport device is fundamentally to be designed here for transport, i.e. so that workpieces and objects can be transported into the work areas and out of the work areas. The transport device can transport, for example, an object for the work device, especially tools or heads for a multiaxis robot, blanks, semifinished products, and the like between the work areas or into the work areas or out of the work areas. Furthermore, there is the possibility that the transport device can carry out a maintenance process on at least one of the work devices, for example, refill a liquid reservoir of the work device, measure the work device, or can carry out other maintenance tasks which arise.

As is furthermore described, the transport device is preferably arranged movably in the transport plane here, for example, along rails. Within the transport plane, the transport device can therefore be moved to the work area, into which or out of which the transport device is to transport a workpiece or an object or in which a maintenance process is to be carried out, in particular, the transport device can engage in the respective work area or can be moved therein at least in some sections.

As already described, the transport plane and the work plane are to be different from one another, i.e. the arrangement of the at least one transport device and the arrangement of the work areas or the work devices are formed in different planes. According to one design of the system, the transport plane can be arranged above or below the work plane. For example, the transport plane can be arranged above the work plane in the vertical direction, i.e. it can be arranged, for example, hanging on a ceiling of a hall. A further possibility is to arrange the transport plane below the work plane, for example, in the form of a tunnel structure. Corresponding combinations can be implemented. It is thus possible that the transport plane or the transport movements and the space of the transport device required for this purpose do not take place in the same plane in which the work devices are arranged. The so-called “logistics areas” can thus be saved in the work plane, since these are located in the transport plane especially provided for this purpose.

The described system can furthermore be refined in that the work areas adjoin one another or a maintenance path is provided between two adjacent work areas. According to the described design, the work areas can directly adjoin one another, so that no further areas are provided between them. Alternatively, a maintenance path, which is narrower or requires less area than typically used logistics areas, for example, can be provided between two work areas. A maintenance path can be understood, for example, as a narrow area in which maintenance tasks are carried out. For example, to enable access for an employee so that this employee can reach the work area from the outside. In other words, work areas can be provided extensively in the work plane, wherein no logistics areas are required in the work plane itself. The area requirement in the work plane can thus be restricted to the area requirement of the work areas.

As described at the outset, the at least one transport device can be movable in the transport plane. In particular, a large number of transport devices, which carry out different tasks, in particular can approach different work areas, can be used simultaneously. The at least one transport device can be movable in the transport plane by means of a two-dimensional transport network, in particular a rail matrix. The transport network therefore defines an x-y plane in the transport plane, which is especially arranged parallel to the work plane, wherein the transport device can be moved in the x direction and in the y direction. A matrix is thus provided, wherein individual work areas can be approached in individual cells of the matrix of the transport network, which are in particular located above or below the cell. As described above, the transport device can engage, in the respective position in the transport plane assigned to the work area, in the adjacent work area, in order to pick up an object or a workpiece there or to introduce it into the work area or to carry out a maintenance task.

At least two transport devices can comprise a position-fixed or movable transport robot or can be designed as such transport robots, wherein the at least two transport robots are designed to pass on the at least one workpiece and/or object between the at least two transport robots. In place of or alternatively to the above-describe movable transport devices, location-fixed transport devices, for example, in the form of gripping arms, can be arranged in the transport plane. Instead of transporting a workpiece and/or object by means of a single transport device, the workpiece and/or object can be moved by being passed on between the individual transport devices. A combination of location-fixed or position-fixed and movable transport devices is likewise possible. The transport robots can especially also be movable, so that they can be moved beyond a defined movement area and can subsequently carry out passing on the workpiece and/or object.

In a further design of the system, it can be provided that at least two transport devices are designed differently, in particular two transport devices assigned to the same work area. In principle, the assignment of transport devices to work areas can be temporary, i.e. a plurality of transport devices is provided, wherein each individual transport device can be assigned as needed and/or temporarily, in particular for carrying out a transport process or maintenance process, to an arbitrary work area. Depending on the requirement, two different transport devices can be assigned here to the same work area, for example, in succession. The transport devices can differ in different parameters in order to carry out different tasks.

The described system can be refined in that at least two transport devices are different in their size and/or their type. For example, different tasks can be fulfilled by means of different transport devices. Especially, one type of transport devices can be intended for carrying out maintenance tasks or providing work material. At least one further type of transport devices can carry tools or equip the work devices with tools. Furthermore, transport devices in different sizes can be provided, for example, different transport devices for the transport of raw material or semifinished products and transport devices for products. Since, on the one hand, comparatively small and light objects and, on the other hand, comparatively large workpieces have to be transported, up to a nearly finished motor vehicle, the different transport devices enable efficient use, so that unnecessarily large transport devices do not have to be used for the transport of comparatively smaller objects.

A combination of size and type of the transport devices can be possible in this case, so that transport devices of different sizes can also have different receptacles for the transport of objects or workpieces. Combined transport devices can thus be provided, which can be designed for transport and for carrying out other tasks, for example, can be configured for carrying out maintenance tasks and transport tasks.

According to a further design of the system, it can be provided that the at least one transport device is movable in an automated manner. The transport device can also be understood in particular as a driverless or autonomous transport device. This can be controlled “intelligently”, for example, by a superordinate control device. It is also possible that the individual transport devices control themselves, for example, based on control commands from decentralized control units assigned to the individual transport devices. A plurality of transport devices can thus be operated simultaneously, each of which fulfills individual tasks. A high level of parallelization and efficiency can thus be achieved in the system.

The described system can furthermore be refined in that at least two transport devices are arranged, in particular movably, in at least two different transport planes and/or at least two work devices are arranged in different work planes. Based on the described design, it is possible to provide more than one transport plane and/or more than one work plane, which are each arranged in different planes. For example, one work plane can be arranged between two transport planes or in each case one transport plane can be provided with one work plane, wherein multiple groups made up of transport plane and work plane can be provided. The area requirement or surface area consumption can thus be reduced further in that multiple parallel planes can be provided for transport and processing.

In addition to the system, the disclosure relates to a method for operating a system for processing workpieces for producing motor vehicles, comprising multiple work areas arranged in a work plane, in each of which at least one work device is arranged, which is designed for processing at least one workpiece, wherein by means of at least one transport device, which is arranged, in particular movably, in a transport plane different from the work plane, at least one object and/or one workpiece is transported out of at least one work area or into at least one work area and/or at least one maintenance process is carried out on the at least one work device.

All advantages, details, embodiments, and/or features which were described with respect to the system are completely transferable to the method.

The disclosure is explained on the basis of exemplary embodiments with reference to the figures. In the schematic representations of the figures:

### BRIEF DESCRIPTION OF THE DRAWINGS

FIG. 1 shows a schematic representation of a system for processing workpieces for producing motor; and

FIG. 2 shows a schematic representation of a system for processing workpieces for producing motor vehicles.

### DETAILED DESCRIPTION OF THE DRAWINGS

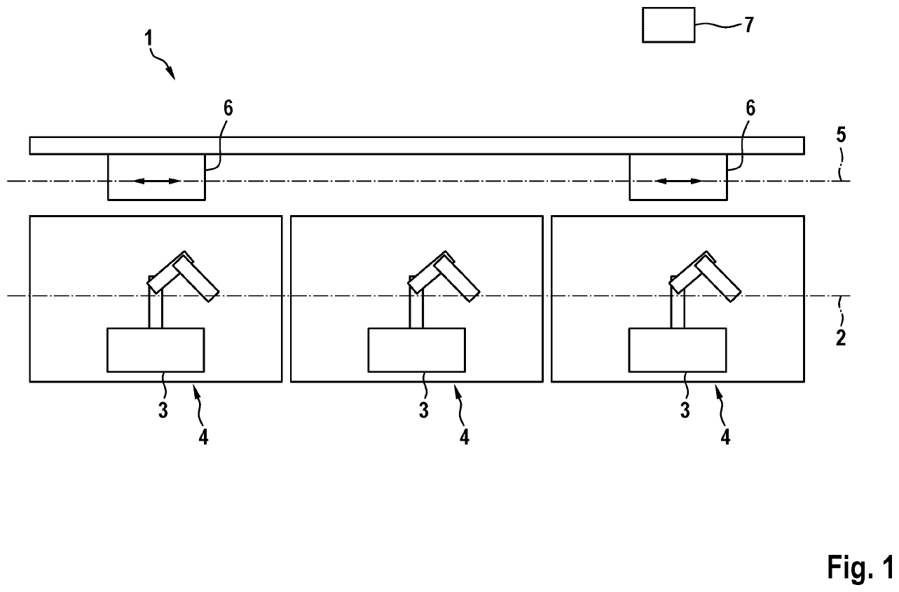

FIG. 1 shows a system 1 for processing workpieces for producing motor vehicles. The system 1 comprises a work plane 2, in which multiple work devices 3 are arranged in individual work areas 4. Solely by way of example, the work devices 3 can be embodied as multiaxis robots or can comprise such multiaxis robots. The work areas 4 can therefore be understood as “cells”, which are arranged in the form of a matrix in the work plane 2, in particular a matrix can be formed from work areas 4 in the work plane 2. The work areas 4 can therefore be arranged in cells and columns or distributed in any arbitrary other way in the work plane 2.

Furthermore, the system 1 comprises a transport plane 5, in which transport devices 6 are arranged. In the exemplary embodiment according to FIG. 1, the transport devices 6 are arranged movably in the transport plane 5, as shown by arrows. In other words, it is therefore possible to selectively move the transport devices 6 to the individual work areas 4 in order to carry out transport tasks or maintenance tasks. The transport devices 6 can be moved, for example, to a specific work area 4, in order to transport an object or a workpiece into the work area 4 or to transport a workpiece or an object out of the work area 4.

Likewise, the transport devices 6 can be moved to a work area 4 in order to carry out a maintenance task there on at least one work device 3 arranged in the work area 4. Although one work device 3 is shown in each work area 4 in the representation in FIG. 1, any arbitrary number of work devices 3 per work area 4 is also possible. The work areas 4 can differ in particular with respect to the processes carried out, i.e. individual work areas 4 can carry out different processes, for example, perform different machining procedures of the workpiece or can process different embodiments of workpieces, i.e. in particular for producing different motor vehicles or differently equipped motor vehicles.

It is apparent that the transport plane 5 is arranged above the work plane 2 in the exemplary embodiment shown in FIG. 1, although this additionally or alternatively could be provided inversely, for example, in the form of a tunnel structure. A maintenance path is shown schematically between the individual work areas 4, which enables, for example, an employee to have access to the work areas 4 within the work plane 2. Alternatively, the maintenance path could be omitted, so that the work areas 4 are arranged directly adjoining one another. In each case, the maintenance path is not to be understood as a logistics area in the conventional sense, since it does not offer a possibility of moving transport devices 6 between the work areas 4.

In principle, various transport devices 6 can be provided, which can implement, for example, different transport tasks or different maintenance tasks or combinations of different tasks. For example, different types of transport devices 6 can be provided, which are designed to carry out different process steps. Likewise, transport devices 6 of different sizes can be provided, which can be configured, for example, to transport objects or small workpieces or large workpieces.

The transport devices 6 are in particular movable in an automated manner, especially controlled by a superordinate control device 7. The control device 7 can output control commands to the individual transport devices 6, on the basis of which the transport devices 6 are configured for movement to the desired work area 4 or the desired position in the transport plane 5.

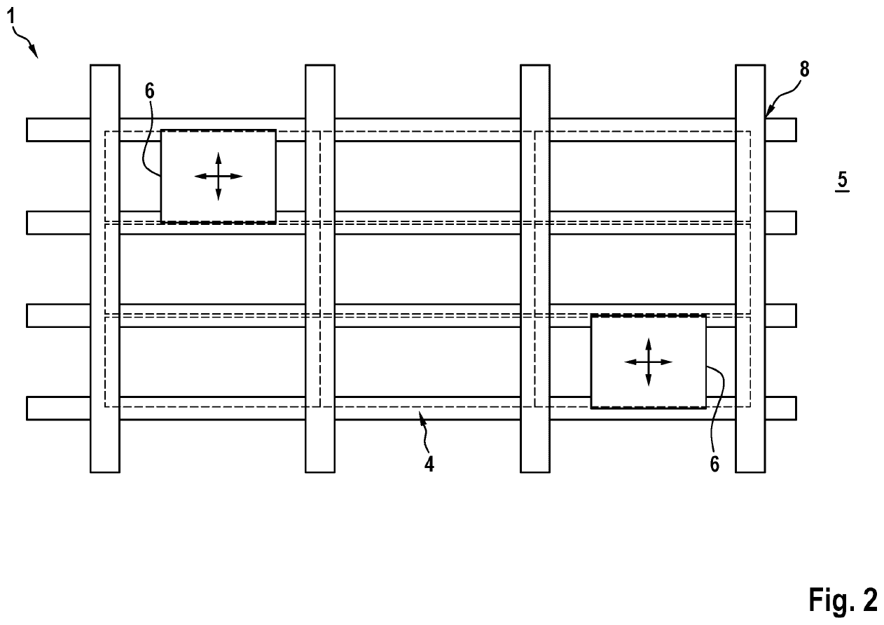

FIG. 2 shows a schematic representation of a top view of the system 1, for example, according to FIG. 1. A two-dimensional transport network 8 is formed in the transport plane 5 in the exemplary embodiment shown, through which the transport devices 6 can be moved or along which the transport devices 6 can be moved. The individual work areas 4 are represented by dashed lines and, as described, can be arranged like a matrix in the work plane 2, for example, below the transport plane shown in FIG. 2. The individual work areas 4 can therefore be understood as cells of the matrix in the work plane 2.

The transport network 8 can form, for example, a rail network extending in the x direction and y direction, so that the transport devices 6 can be moved along the rails, which can extend in the x direction and y direction, in order to be able to be moved into those positions in the transport plane 5 which correspond to the work areas 4 in the work plane 2. As shown in FIG. 1, for example, the transport devices 6 can be positioned for this purpose above the work areas 4 and can engage “from above” into the work areas 4 or can be moved at least in some sections therein, for example, in order to carry out the processing.

The preceding description is transferable to work planes 2 or work areas 4 and transport planes 5 arranged in other ways, so that a movement of the transport devices 6 below the work areas 4 is also possible in the context of a tunnel structure. In addition to the exemplary embodiment shown, it is also possible to provide multiple work planes 2 and/or multiple transport planes 5. For example, in the representation in FIG. 1, a further transport plane 5 can be arranged above or below the work plane 2. Multiple work planes 2 can also be implemented, for example, one above another. A further exemplary option can be to arrange work planes 2 and transport planes 5 alternately in the vertical direction. The described variants are combinable with one another as desired.

The advantages, details, and features described with reference to the individual exemplary embodiments can be combined with one another, exchanged with one another, and transferred to one another as desired. The method described herein can be carried out on the system 1.

### LIST OF REFERENCE NUMERALS

1 system
2 work plane
3 work device
4 work area
5 transport plane
6 transport device
7 control device
8 transport network

1.-10. (canceled)

11. A system for processing workpieces for producing motor vehicles, comprising:
multiple work areas arranged in a work plane, in each of which at least one work device is arranged, which is configured to process at least one workpiece, wherein
at least one transport device, which is movably arranged in a transport plane that is different from the work plane and that is configured to transport at least one object and/or one workpiece out of at least one work area or into at least one work area and/or to carry out at least one maintenance process on the at least one work device.

12. The system as claimed in claim 11, wherein the transport plane is arranged above or below the work plane.

13. The system as claimed in claim 11, wherein the at least one work area adjoins one another or a maintenance path is provided between two adjacent work areas.

14. The system as claimed in claim 11, wherein the at least one transport device is movable in the transport plane via a rail matrix two-dimensional transport network.

15. The system as claimed in claim 11, wherein the at least one transport device is at least two transport devices comprise a position-fixed or movable transport robot or are configured as transport robots, and at least two transport robots are configured to pass on the at least one workpiece and/or object between the at least two transport robots.

16. The system as claimed in claim 15, wherein at least two transport devices are designed differently, the at least two transport devices being assigned to a same work area.

17. The system as claimed in claim 16, wherein the at least two transport devices are different in size and/or type.

18. The system as claimed in claim 11, wherein the at least one transport device is movable in an automated manner.

19. The system as claimed in claim 15, wherein the at least two transport devices are movably arranged in at least two different transport planes, and/or at least two work devices are arranged in different work planes.

20. A method for operating a system for processing workpieces for producing motor vehicles, comprising:
arranging multiple work areas in a work plane, in each of which at least one work device is arranged, and which is configured to process at least one workpiece, wherein via at least one transport device, which is movably arranged in a transport plane different from the work plane, at least one object and/or one workpiece is transported out of at least one work area or into at least one work area and/or at least one maintenance process is carried out on the at least one work device.
